(19) United States
(12) Patent Application Publication
(10) Pub. No.: US 2024/0194471 A1
(43) Pub. Date: Jun. 13, 2024

(54) NEBULISER OUTLET

(71) Applicant: Micromass UK Limited, Wilmslow (GB)

(72) Inventors: Ian Trivett, Cheadle (GB); Mark Walford, Wilmslow (GB); Daniel James Kenny, Knutsford (GB); Stevan Bajic, Sale (GB); Suloke Mathai, Macclesfield (GB)

(73) Assignee: Micromass UK Limited, Wilmslow (GB)

(21) Appl. No.: 18/556,409

(22) PCT Filed: Apr. 21, 2022
(86) PCT No.: PCT/GB2022/051008

§ 371 Date: Oct. 20, 2023

(30) Foreign Application Priority Data
Apr. 21, 2021 (GB) 2105676.7

(51) Int. Cl. H01J 49/16; H01J 49/04

(52) U.S. Cl. CPC H01J 49/167; H01J 49/045

(57) ABSTRACT

A nebuliser outlet (20) comprises one or more first channels (24), wherein the nebuliser outlet (20) is configured such that liquid received by the nebuliser outlet (20) can pass to one or more nebulisation regions via the one or more first channels (24), and one or more second channels (25), wherein the nebuliser outlet (20) is configured such that gas received by the nebuliser outlet (20) can pass to the one or more nebulisation regions via the one or more second channels (25). The one or more first channels (24) comprise a first portion (24a) and a second portion (24b), wherein the first portion (24a) comprises a tubular channel, and wherein the second portion (24b) comprises multiple channels, an annular channel, or a segmented annular channel. The one or more second channels (25) converge with the second portion (24b) at the one or more nebulisation regions.

### CROSS-REFERENCE TO RELATED APPLICATION

This application claims priority from, and the benefit of, United Kingdom patent application No. 2105676.7 filed on 21 Apr. 2021. The entire contents of that application is incorporated herein by reference.

### FIELD OF THE INVENTION

The present invention relates generally to ion sources and in particular to nebulisers for ion sources.

### BACKGROUND

Ionisation techniques such as Electrospray Ionisation (ESI) utilise a nebuliser to generate a spray of droplets.

Such nebulisers typically comprise a liquid capillary and a gas capillary. The liquid capillary is typically arranged coaxially within the gas capillary, with the liquid-emitting outlet of the liquid capillary extending beyond the distal end of the gas capillary. A flow of liquid supplied to the liquid capillary is nebulised by a nebulising gas flow supplied to the gas capillary.

The Applicants believes that there remains scope for improvements to nebulisers.

### SUMMARY

According to an aspect, there is provided a nebuliser outlet comprising: one or more first channels and one or more second channels;
wherein the nebuliser outlet is configured such that liquid received by the nebuliser outlet can pass to one or more nebulisation regions via the one or more first channels;
wherein the nebuliser outlet is configured such that gas received by the nebuliser outlet can pass to the one or more nebulisation regions via the one or more second channels; and wherein the nebuliser outlet comprises (is) a single integrated component.

The nebuliser outlet may be configured such that liquid is directly provided to the one or more nebulisation regions by the one or more first channels, and such that gas is directly provided to the one or more nebulisation regions by the one or more second channels.

Various embodiments are directed to a nebuliser outlet (a nebuliser outlet tip) having one or more first channels and one or more second channels. The one or more first channels and one or more second channels may be arranged between an inlet end and an outlet end of the nebuliser outlet. The nebuliser outlet may be configured such that liquid received by the nebuliser outlet will pass to one or more nebulisation regions via the one or more first channels, and such that gas received by the nebuliser outlet will pass to the one or more nebulisation regions via the one or more second channels. The nebuliser outlet may be configured such the gas can nebulise the liquid in the one or more nebulisation regions.

As will be described in more detail below, the nebuliser outlet is configured such that liquid is directly provided to the one or more nebulisation regions by the one or more first channels of the nebuliser outlet, and such that gas is directly provided to the one or more nebulisation regions by the one or more second channels of the nebuliser outlet. In other words, the nebuliser outlet is configured such that the flow of the liquid and the flow of gas into the one or more nebulisation regions is guided by (only) the one or more first channels and the one or more second channels of the nebuliser outlet. In particular, the nebuliser outlet may be configured such that the position and/or orientation of (the or each outlet of) the one or more first channels relative to (the or each outlet of) the one or more second channels is (permanently) fixed. This means that geometric parameters that affect the interaction between the liquid and the nebulising gas (in the one or more nebulisation regions) are substantially fixed by the geometry of the nebuliser outlet alone (independently of the precise position of e.g. a capillary that provides the liquid to the nebuliser outlet).

In addition, forming the nebuliser outlet as a single integrated component can significantly reduce manufacturing imperfections in the part.

The overall effect of this is to significantly reduce variation in the performance of the nebuliser, for example from one use to the next, and from one nebuliser to the next.

Various embodiments accordingly provide an improved nebuliser outlet.

The nebuliser outlet may be formed using an additive manufacturing process. The use of additive manufacturing can significantly reduce manufacturing imperfections in the part, and also facilitates the creation of nebuliser outlet geometries that would be impractical (or even impossible) to form using conventional subtractive machining processes.

The nebuliser outlet may be formed using Selective Laser Melting (SLM).

The nebuliser outlet may be formed using electron-beam additive manufacturing.

The nebuliser outlet may comprise one or more gas inlets. One or more or each of the gas inlets may be arranged at the inlet end. Additionally or alternatively, one or more of each of the gas inlets may be arranged elsewhere between the inlet end and the outlet end, such as on a side wall of the nebuliser outlet between the inlet end and the outlet end.

The nebuliser outlet may comprise one or more liquid inlets. One or more or each of the liquid inlets may be arranged at the inlet end. Additionally or alternatively, one or more of each of the liquid inlets may be arranged elsewhere between the inlet end and the outlet end, such as on a side wall of the nebuliser outlet between the inlet end and the outlet end.

The nebuliser outlet may be configured such that liquid provided to a liquid inlet of the nebuliser outlet can pass via the one or more first channels to the one or more nebulisation regions. The nebuliser outlet may be configured such that gas provided to a gas inlet of the nebuliser outlet can pass via the one or more second channels to the one or more nebulisation regions.

The nebuliser outlet may be configured such that gas provided to (a gas inlet of) the nebuliser outlet can pass via the one or more second channels to the one or more nebulisation regions, and can nebulise liquid in the one or more nebulisation regions.

The nebuliser outlet may comprise one or more outlet apertures arranged at the outlet end. The one or more first channels may be configured to pass liquid (from the one or more liquid inlets) to or close to the one or more outlet apertures. The one or more second channels may be configured to pass gas (from the one or more gas inlets) to or close to the one or more outlet apertures. The nebuliser outlet may be configured such that gas provided to (a gas inlet of) the nebuliser outlet can pass via the one or more second channels to the one or more outlet apertures, and can nebulise the liquid, such that a spray of droplets is emitted from one or more or each outlet aperture.

Each of the one or more first channels may be arranged between the inlet end and the outlet end. One or more or each of the one or more first channels may extend along the entire length of the nebuliser outlet between the inlet end and the outlet end, and/or one or more or each of the one or more first channels may extend along only part (some but not all) of the length of the nebuliser outlet between the inlet end and the outlet end.

Each of the one or more second channels may be arranged between the inlet end and the outlet end. One or more or each of the one or more second channels may extend along the entire length of the nebuliser outlet between the inlet end and the outlet end, and/or one or more or each of the one or more second channels may extend along only part (some but not all) of the length of the nebuliser outlet between the inlet end and the outlet end.

One or more or each of the first channel(s) may be separate from the one or more second channel(s) for the entire length of the nebuliser outlet. Alternatively, one or more or each of the first channel(s) may be separate from the one or more second channel(s) for at least some (but not all) of the length of the nebuliser outlet.

The one or more or first channel(s) may be separate from the one or more second channel(s) at the inlet end. Alternatively, the one or more second channel(s) may diverge from the one or more first channel(s) at one or more points along the length of the nebuliser outlet.

The one or more or first channel(s) may be separate from the one or more second channel(s) at the outlet end. In these embodiments, the nebuliser outlet may be configured such that gas provided to the nebuliser outlet can meet (and nebulise) liquid in one or more nebulisation region(s) downstream of the outlet end (downstream of the outlet aperture). That is, the one or more nebulisation region(s) may be external from (downstream of) the nebuliser outlet.

Alternatively, one or more or each of the first channel(s) may converge with one or more of the second channel(s) at one or more convergence region(s) within the nebuliser outlet (before the outlet end). The or each convergence region(s) may be arranged at or close to the outlet end and/or the outlet aperture. In these embodiments, the nebuliser outlet may be configured such that gas provided to the nebuliser outlet can meet (and nebulise) liquid in the one or more convergence region(s). In other words, the one or more convergence region(s) may be the one or more nebulisation region(s). Thus, the one or more nebulisation regions may be within the nebuliser outlet, and the one or more first channels and the one or more second channels may converge at the one or more nebulisation regions.

One or more of the second channel(s) may (coaxially) surround one or more of the first channel(s). For example, the one or more first channels may comprise a (single) tubular channel, the one or more second channels may comprise an annular channel or a segmented annular channel, and the second annular channel or segmented annular channel may (coaxially) surround the first tubular channel.

Similarly, an outlet or outlets of the one or more second channel(s) may (coaxially) surround an outlet or outlets of the one or more first channel(s). For example, the one or more first channels may comprise a (single) outlet aperture, the one or more second channels may comprise an annular outlet or a segmented annular outlet, and the second annular outlet or segmented annular outlet may (coaxially) surround the first outlet aperture.

One or more of the first channel(s) may (coaxially) surround one or more of the second channel(s). For example, the one or more second channels may comprise a (single) tubular channel, the one or more first channels may comprise an annular channel or a segmented annular channel, and the first annular channel or segmented annular channel may (coaxially) surround the second tubular channel.

Similarly, an outlet or outlets of the one or more first channel(s) may (coaxially) surround an outlet or outlets of the one or more second channel(s). For example, the one or more second channels may comprise a (single) outlet aperture, the one or more first channels may comprise an annular outlet or a segmented annular outlet, and the first annular outlet or segmented annular outlet may (coaxially) surround the second outlet aperture.

The one or more second channels may comprise an inner second channel and an outer second channel. For example, the inner second channel may comprise a (single) tubular channel, and the outer second channel may comprise an annular channel or a segmented annular channel. The one or more first channels may (coaxially) surround the inner second channel. For example, the one or more first channels may comprise an annular channel or a segmented annular channel, and the first annular channel or segmented annular channel may (coaxially) surround the inner tubular channel. The outer second channel may (coaxially) surround the one or more first channels. For example, the outer annular channel or segmented annular channel may (coaxially) surround the first annular channel or segmented annular channel.

According to an aspect, there is provided a nebuliser outlet comprising:
one or more first channels, wherein the nebuliser outlet is configured such that liquid received by the nebuliser outlet can pass to one or more nebulisation regions via the one or more first channels;
an inner second channel and an outer second channel, wherein the nebuliser outlet is configured such that gas received by the nebuliser outlet can pass to the one or more nebulisation regions via the inner second channel and the outer second channel;
wherein the one or more first channels surround the inner second channel, and wherein the outer second channel surrounds the one or more first channels.

The one or more second channels may comprise an inner outlet and an outer outlet. For example, the inner second channel may comprise a (single) outlet aperture, and the outer second channel may comprise an annular outlet or a segmented annular outlet. An outlet or outlets of the one or more first channels may (coaxially) surround the outlet of the inner second channel (i.e. the inner outlet aperture). For example, the one or more first channels may comprise an annular outlet or a segmented annular outlet, and the first annular outlet or segmented annular outlet may (coaxially) surround the inner outlet aperture (of the inner second channel). An outlet or outlets of the outer second channel may (coaxially) surround the outlet or outlets of the one or more first channels. For example, the outer annular outlet or segmented annular outlet may (coaxially) surround the first annular outlet or segmented annular outlet.

The nebuliser outlet may comprise a secondary nebulisation region. The nebuliser outlet may be configured such that an initial spray of droplets produced by the nebuliser outlet can be further nebulised in the secondary nebulisation region. For example, the nebuliser outlet may be configured such that gas provided to the secondary nebulisation region can further nebulise the initial spray of droplets in the secondary nebulisation region.

According to an aspect, there is provided a nebuliser comprising:
a nebuliser outlet configured to produce an initial spray of droplets; and
a secondary nebulisation region, wherein the nebuliser is configured such that gas provided to the secondary nebulisation region can further nebulise the initial spray of droplets in the secondary nebulisation region.

The nebuliser (outlet) may be configured such that gas provided to the secondary nebulisation region can further nebulise the initial spray of droplets in the secondary nebulisation region so as to produce a secondary spray of droplets.

The one or more first channels may comprise a first portion and a second portion. The first portion may comprise a single tubular channel, and the second portion may comprise multiple channels, an annular channel, or a segmented annular channel. Thus, the one or more first channels may comprise a tubular channel which diverges into multiple channels, an annular channel, or a segmented annular channel.

The one or more nebulisation regions may be within the second portion of the one or more first channels, i.e. within the multiple channels, annular channel, or segmented annular channel. The one or more second channels may converge with the second portion (with the multiple channels, annular channel, or segmented annular channel) at the one or more nebulisation regions. Thus, the nebuliser outlet may be configured such that gas provided to the nebuliser outlet can pass via the one or more second channels to the one or more nebulisation regions in the second portion of the one or more first channels, and can meet and nebulise liquid in the one or more nebulisation regions.

According to an aspect, there is provided a nebuliser outlet comprising:
one or more first channels, wherein the nebuliser outlet is configured such that liquid received by the nebuliser outlet can pass to one or more nebulisation regions via the one or more first channels; and
one or more second channels, wherein the nebuliser outlet is configured such that gas received by the nebuliser outlet can pass to the one or more nebulisation regions via the one or more second channels;
wherein the one or more first channels comprise a first portion and a second portion, wherein the first portion comprises a single tubular channel, and wherein the second portion comprises multiple channels, an annular channel, or a segmented annular channel; and
wherein the one or more second channels converge with the second portion at the one or more nebulisation regions.

The nebuliser outlet may be configured such that a (total) surface area of liquid provided to the nebuliser outlet is increased when the liquid passes from the first portion to the second portion of the one or more first channels. That is, the nebuliser outlet may be configured such that the (total) surface area of liquid provided to the nebuliser outlet is increased when the liquid passes from the tubular channel (and diverges) into the multiple channels, annular channel, or segmented annular channel.

An inner wall of the second part of the one or more first channels (i.e. of the multiple channels, annular channel or segmented annular channel) may define a surface. The surface and/or the second part of the one or more first channels may be configured such that a film of liquid is formed on the surface when liquid encounters the surface. Thus, the nebuliser outlet may be configured such that a film of liquid is formed on the surface when the liquid passes from the first portion to the second portion of the one or more first channels. That is, the nebuliser outlet may be configured such that a film of liquid is formed on the surface when the liquid passes from the tubular channel (and diverges) into the multiple channels, annular channel, or segmented annular channel. The nebuliser outlet may be configured such that the liquid passes through the second portion the one or more first channels (i.e. the multiple channels, annular channel, or segmented annular channel) in the form of one or more films.

The nebuliser outlet may be configured such that gas provided to the nebuliser outlet can pass via the one or more second channels to the one or more nebulisation regions, and can nebulise the film(s) of liquid in the one or more nebulisation regions.

According to an aspect, there is provided a nebuliser comprising:
the nebuliser outlet described above; and
a liquid capillary.

The outlet of the liquid capillary may be arranged upstream of the nebulisation region.

The nebuliser outlet may be configured such that, when a capillary is installed in the (first channel of the) nebuliser outlet, an outlet of the capillary is arranged upstream of (withdrawn from) the nebulisation region (within the first channel). Configuring the nebuliser so that the outlet of the capillary is arranged upstream of the nebulisation region means that geometric parameters that affect the interaction between the liquid and the nebulising gas (in the nebulisation region) can be precisely controlled and/or substantially fixed by the geometry of the nebuliser outlet alone (independently of the precise position of the capillary outlet relative to the nebuliser outlet when the capillary is installed in the (first channel of the) nebuliser outlet).

The liquid capillary may be configured to interfere with an inner wall of the nebuliser outlet when the liquid capillary is installed in the nebuliser outlet. The outlet may be configured such that when the liquid capillary interferes with an inner wall of the nebuliser outlet, the outlet of the liquid capillary is arranged within the nebuliser outlet and upstream of the nebulisation region.

According to an aspect, there is provided an ion source comprising the nebuliser outlet and/or the nebuliser described above.

The ion source may comprise an Electrospray Ionisation (ESI) ion source, a Desorption Electrospray Ionisation (DESI) ion source, a Desorption Electro-Flow Focusing Ionisation (DEFFI) ion source, an impactor ion source, or an Atmospheric Pressure Chemical Ionisation (APCI) ion source.

According to an aspect, there is provided an analytical instrument such as a mass and/or ion mobility spectrometer, comprising the nebuliser outlet and/or the nebuliser and/or the ion source described above.

According to an aspect, there is provided a method of nebulising a liquid, the method comprising using the nebuliser outlet and/or the nebuliser described above to nebulise a liquid.

According to an aspect, there is provided a method of ionisation, the method comprising using the nebuliser outlet and/or the nebuliser and/or the ion source described above to ionise an analyte.

According to an aspect, there is provided a method of analysing an analyte, the method comprising using the ion source described above to ionise an analyte so as to produce analyte ions, and analysing the analyte ion and/or ions derived from the analyte ions.

Analysing the analyte ions and/or ions derived from the analyte ions may comprise determining the mass to charge ratio, mass, charge, ion mobility and/or collision cross section of the analyte ions and/or of the ions derived from the analyte ions, for example using an analytical instrument such as a mass and/or ion mobility spectrometer.

According to an aspect, there is provided a method of manufacturing a nebuliser outlet, the method comprising manufacturing the nebuliser outlet described above using an additive manufacturing process.

The additive manufacturing process may comprise Selective Laser Melting (SLM).

The additive manufacturing process may comprise electron-beam additive manufacturing.

Manufacturing the nebuliser outlet may comprise forming the nebuliser outlet from the outlet end to the inlet end or forming the nebuliser outlet from the inlet end to the outlet end.

### BRIEF DESCRIPTION OF THE DRAWINGS

Various embodiments will now be described, by way of example only, and with reference to the accompanying drawings in which:

FIG. 1 shows schematically a cross-sectional view of a conventional Electrospray Ionisation (ESI) ion source nebuliser;

FIG. 2 shows schematically a cross-sectional view of a nebuliser assembly in accordance with various embodiments;

FIG. 3A shows schematically a cross-sectional view of a nebuliser tip in accordance with various embodiments, and FIG. 3B shows schematically a cut-away perspective view of a nebuliser tip in accordance with various embodiments;

FIG. 4A shows schematically a cross-sectional view of a nebuliser tip in accordance with various embodiments, and FIG. 4B shows schematically a cross-sectional view of a nebuliser tip in accordance with various embodiments;

FIG. 5 shows schematically a cross-sectional view of a nebuliser assembly in accordance with various embodiments;

FIG. 6 shows schematically extracted “wet” volumes of the nebuliser tip of FIG. 5 in accordance with various embodiment;

FIG. 7 shows schematically a cross-sectional view of a nebuliser tip together with an analytical instrument inlet in accordance with various embodiments;

FIG. 8A shows schematically a cross-sectional view of a nebuliser tip in accordance with various embodiments, and FIG. 8B shows schematically a cross-sectional view of a nebuliser tip in accordance with various embodiments;

FIG. 9A shows schematically a cross-sectional view of a nebuliser tip in accordance with various embodiments, FIG. 9B shows schematically a cross-sectional view of a nebuliser tip in accordance with various embodiments, and FIG. 9C shows schematically a cross-sectional view of a nebuliser tip in accordance with various embodiments;

FIG. 10 shows schematically a cross-sectional view of a nebuliser tip in accordance with various embodiments;

FIG. 11A shows schematically a cut-away perspective view of a nebuliser tip in accordance with various embodiments, FIG. 11B shows schematically a perspective view of a nebuliser tip in accordance with various embodiments, FIG. 11C shows schematically a cross-sectional view of a nebuliser tip in accordance with various embodiments, and FIG. 11D shows schematically a cross-sectional view of a nebuliser assembly in accordance with various embodiments;

FIG. 12A shows schematically a perspective view of a nebuliser tip in accordance with various embodiments, FIG. 12B shows schematically a perspective view of the outlet end of a nebuliser tip in accordance with various embodiments, and FIG. 12C shows schematically a cut-away perspective view of a nebuliser tip in accordance with various embodiments; and

FIG. 13A shows schematically a perspective view of a nebuliser tip in accordance with various embodiments, FIG. 13B shows schematically a perspective view of the outlet end of a nebuliser tip in accordance with various embodiments, and FIG. 13C shows schematically a cut-away perspective view of a nebuliser tip in accordance with various embodiments.

### DETAILED DESCRIPTION

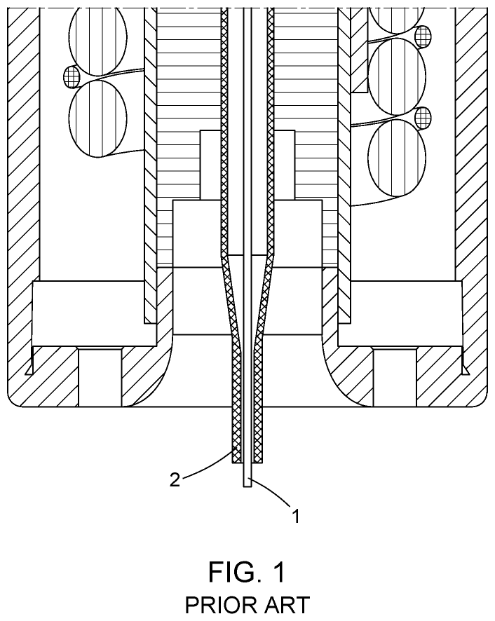

FIG. 1 shows schematically a cross sectional view of a conventional nebuliser of an Electrospray Ionisation (ESI) ion source. As shown in FIG. 1, the nebuliser comprises a liquid capillary 1 and a gas capillary 2. The liquid capillary 1 is arranged coaxially within the gas capillary 2, with the liquid-emitting outlet of the liquid capillary 1 extending beyond the distal end of the gas capillary 2. A flow of liquid supplied to the liquid capillary 1 is nebulised by a nebulising gas flow supplied to the gas capillary 2.

In such ion source nebulisers, the position of the liquid-emitting outlet of the liquid capillary 1 relative to the nebuliser outlet of the gas capillary 2 can significantly affect the properties of the nebulised spray. However, it can be challenging to ensure that the position of the liquid capillary relative to the nebuliser outlet is consistently reproduced, for example from one use to the next (for example after uninstalling and re-installing a liquid capillary), and from one nebuliser to the next.

Various embodiments are directed to a nebuliser outlet (a nebuliser outlet tip) that is configured in such a way that the geometric parameters that affect the interaction between the liquid and the nebulising gas are substantially fixed by the geometry of the nebuliser outlet alone (independently of the precise position of e.g. a capillary that provides the liquid to the nebuliser outlet).

In particular, the nebuliser outlet comprises one or more first channels and one or more second channels, where liquid received by the nebuliser outlet can pass to a nebulisation region via the one or more first channels, and gas received by the nebuliser outlet can pass to the nebulisation region via the one or more second channels. The nebuliser outlet is configured such that liquid is directly provided to the nebulisation region by the one or more first channels, and such that gas is directly provided to the nebulisation region by the one or more second channels.

This means that geometric parameters that affect the interaction between the liquid and the nebulising gas (in the nebulisation region) are substantially fixed by the geometry of the nebuliser outlet, i.e. by the geometry of the one or more first channels and one or more second channels, alone. Accordingly, variation in the performance of the nebuliser, for example from one use to the next, and from one nebuliser to the next can be significantly reduced.

In addition, the nebuliser outlet is (comprises) a single integrated component. This can significantly reduce manufacturing imperfections, and thereby further reduce variation in the performance of the nebuliser outlet, for example from one use to the next, and from one nebuliser outlet to the next.

Various embodiments accordingly provide an improved nebuliser outlet.

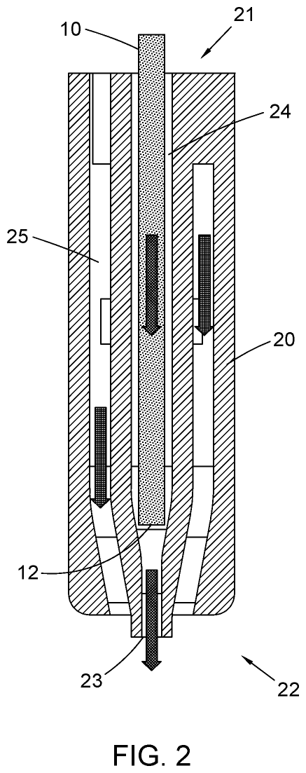

FIG. 2 shows schematically a cross-sectional view of a nebuliser outlet assembly in accordance with various embodiments.

As shown in FIG. 2, the nebuliser assembly comprises a nebuliser outlet 20 which has an inlet end 21 and an outlet end 22. The nebuliser outlet 20 may have a central axis, which may extend between the inlet end 21 and the outlet end 22 in an axial direction. A radial direction may extend outwardly from the central axis (may have the central axis as its origin).

The outlet end 22 of the nebuliser outlet 20 may comprise an outlet aperture 23. The outlet aperture 23 may be arranged on (coaxial with) the central axis of the nebuliser outlet 20. However, it would also be possible for the outlet aperture 23 to be arranged elsewhere, such as in a non-coaxial position, such as off-axis from the central axis of the nebuliser outlet 20. In FIG. 2, the nebuliser outlet 20 comprises a single outlet aperture 23, but it would also be possible for the nebuliser outlet 20 to comprise multiple outlet apertures.

The nebuliser outlet 20 may be configured to emit a spray of droplets (generally in the axial direction), such as a spray of nebulised droplets, from its outlet end 22 (e.g. from the (or each) outlet aperture 23). To do this, the nebuliser outlet 20 may be configured to receive a flow of liquid and a flow of gas, and to cause the liquid to be nebulised by the gas so as to produce the spray of droplets.

The nebuliser outlet 20 comprises one or more gas inlets. The nebuliser outlet 20 may be configured to receive the flow of gas from a gas supply (not shown) which may be connected to the gas inlet(s). As illustrated in FIG. 2, a gas inlet may be arranged at the inlet end 21. However, in general it would be possible for the nebuliser outlet 20 to include a gas inlet elsewhere, for example between the inlet end 21 and the outlet end 22, such as on a side wall of the nebuliser 20 outlet between the inlet end 21 and the outlet end 22.

Similarly, the nebuliser outlet comprises one or more liquid inlets, and the nebuliser outlet 20 may be configured to receive the flow of liquid from a liquid supply via the one or more liquid inlets. As illustrated in FIG. 2, a liquid inlet may be arranged at the inlet end 21. However, in general it would be possible for the nebuliser outlet 20 to include a liquid inlet elsewhere, for example between the inlet end 21 and the outlet end 22, such as on a side wall of the nebuliser 20 outlet between the inlet end 21 and the outlet end 22.

As shown in FIG. 2, the nebuliser outlet 20 comprises a first (internal) channel 24 arranged between the inlet end 21 and the outlet end 22. The first channel 24 may be arranged to extend along the nebuliser outlet 20 between the inlet end 21 and the outlet end 22, such as along the central axis of the nebuliser outlet 20. Other arrangements would be possible, such as the first channel 24 being non-straight, off-axis, etc. In FIG. 2, the nebuliser outlet 20 comprises a single first channel 24, but it would be possible for the nebuliser outlet 20 to comprise plural first channels.

The first channel(s) 24 is configured to pass liquid to the outlet end 22 (as indicated by the arrows in FIG. 2). In other words, the first channel 24 is configured such that liquid received by the nebuliser outlet 20 is passed to the outlet end 22 via the first channel 24.

The first channel 24 may have any suitable form. For example, the first channel may be (at least in part) a tube such as a generally cylindrical tube (which may be arranged along the central axis of the nebuliser outlet 20). The first channel 24 may have any suitable cross sectional shape, such as a circular, elliptical or other shape.

The first channel 24 may have the same cross-sectional area (e.g. the same inner diameter) along its entire (axial) length. Alternatively, the first channel 24 may have plural different cross sectional areas (plural different inner diameters) along its (axial) length. For example, as shown in FIG. 2, the first channel 24 may have a tapered portion arranged at or close to the outlet end 22, i.e. where the tapered portion is configured such that its cross-sectional area (its inner diameter) decreases from the inlet end 21 towards the outlet end 22. Other arrangements would be possible.

The nebuliser outlet 20 comprises one or more second (internal) channels 25 arranged between the inlet end 21 and the outlet end 22. The one or more second channels 25 are configured to pass gas to the outlet end 22 (as indicated by the arrows in FIG. 2). In other words, the one or more second channels 25 are configured such that gas received by the nebuliser outlet 20 is passed to the outlet end 22 via the one or more second channels 25.

The or each second channel 25 may have any suitable form. For example, the or each second channel may be a tube such as a generally cylindrical tube. The or each second channel may have any suitable cross sectional shape, such as a circular, elliptical or other shape.

As shown in FIG. 2, the or each of the one or more second channels 25 may each be arranged to run alongside the central axis of the nebuliser outlet 20, such as being (at least in part) parallel to the central axis of the nebuliser outlet 20 (and so parallel to the first channel 24). However, one or more or each second channel need not be entirely or precisely parallel to the central axis. In general, one or more or each second channel may have any suitable configuration such as a tapered configuration, zig-zag configuration, helix configuration, matrix configuration, and the like.

The nebuliser outlet 20 may comprise any suitable number of second channels. For example, the nebuliser outlet 20 may comprise a single second channel, or plural second channels, such as two, three, four, five or more second channels. Where there are plural second channels, each channel may be substantially identical (although this need not be the case), and may for example, be arranged in a rotationally symmetric configuration (about the central axis of the nebuliser outlet 20) (although this need not be the case).

In particular embodiments, the one or more channels 25 comprises an annular channel. The annular channel 25 may coaxially surround the central first channel 24 for some or most of the length of the nebuliser outlet 20. This arrangement has been found to improve reproducibility with respect to the manufacturing process. In particular, an annular channel 25 is much less susceptible to being blocked by excess powder during the additive manufacturing (e.g. SLM) process, when compared with individual tubular channels (which can become blocked with excess powder).

Alternatively, the one or more second channels 25 may comprise a segmented annular channel, i.e. where the cross-sectional shape of each of the one or more second channels 25 approximately corresponds to an annular sector (annulus sector). The segmented annular channel 25 may coaxially surround the central first channel 24 for some or most of the length of the nebuliser outlet 20. The annular channel 25 can be segmented into any suitable number of channels, such as two, three, four, five, etc. channels. Other arrangements would be possible.

The or each second channel 25 may have the same cross-sectional area (e.g. the same inner diameter) along its entire (axial) length. Alternatively, the or each second channel 25 may have plural different cross sectional areas (plural different inner diameters) along its (axial) length. For example, as shown in FIG. 2, the second channel 25 may have a tapered portion arranged at or close to the outlet end 22, i.e. where the tapered portion is configured such that its cross-sectional area (its inner diameter) decreases from the inlet end 21 towards the outlet end 22.

In the embodiment depicted in FIG. 2, the nebuliser outlet 20 is configured to receive the flow of liquid from a liquid capillary 10. The liquid capillary 10 may comprise an inlet end and an outlet end 12, and may be configured such that liquid provided to the inlet is emitted from the outlet end 12. The liquid capillary 10 may be formed from an electrically conductive material such as a metal such as stainless steel. The liquid capillary 10 may have any suitable configuration, such as for example, the configuration described in WO 2015/040384, the content of which is incorporated herein by reference.

As illustrated in FIG. 2, the first channel 24 may be configured to receive the liquid capillary 10 when the liquid capillary 10 is installed in the nebuliser outlet 20. However, it would also be possible for the nebuliser outlet 20 to comprise another channel or other structure configured to receive the liquid capillary 10. In the embodiment depicted in FIG. 2, the first channel 24 is configured such that, when installed in the nebuliser outlet, the liquid capillary 10 passes through the centre of the nebuliser outlet 20. That is, the liquid capillary 10 may be arranged along the central axis of the nebuliser outlet 20. However, it would also be possible for the liquid capillary 10 to be arranged in an off centre (non-concentric) manner, such as (at least partially) parallel to the central axis of the nebuliser outlet 20.

Although FIG. 2 shows an arrangement in which a liquid capillary 10 provides the liquid to the nebuliser outlet 20, in general the liquid could be provided to the nebuliser outlet 20 in any suitable manner, and the nebuliser assembly need not comprise a capillary 10. In general, any suitable liquid supply may be used to supply the liquid to nebuliser outlet 20, and e.g. may be connected to the (or each) liquid inlet.

In the embodiment depicted in FIG. 2, the nebuliser outlet 20 is configured such that a nebulisation region is provided downstream of the outlet end 22 (downstream of the outlet aperture 23). That is, the nebuliser outlet 20 is configured such that the liquid will meet (and interact with) the nebulising gas in a region beyond the outlet end 22 (beyond the outlet aperture 23) such that a (nebulised) spray of droplets is formed in that region. (It would, however, be possible for a nebulisation region to be formed elsewhere, such as within the nebuliser outlet 20, as will be described further below). (Although in FIG. 2 there is in effect a single nebulisation region, in embodiments, the nebuliser outlet 20 can comprise multipole nebulisation regions.)

In particular, in FIG. 2, both the outlet of the first channel 24 (the outlet aperture 23) and the outlet of the second channel 25 are provided at the outlet end 22 of the nebuliser outlet 20. The outlet of the second channel 25 coaxially surrounds the outlet of the first channel 24 (the outlet aperture 23), and the outlet of the first channel 24 protrudes beyond the outlet of the second channel 25 (although this need not be the case, as will be described further below). This means that gas exiting the outlet of the second channel 25 will meet and nebulise the liquid exiting the outlet aperture 23 in a nebulisation region downstream of the outlet aperture 23.

As also shown in FIG. 2, in the case where a liquid capillary 10 is used to supply liquid to the nebuliser outlet 20, the nebuliser outlet 20 is configured such that, when the liquid capillary 10 is installed in the nebuliser outlet 20, the outlet (tip) 12 of the liquid capillary 10 does not protrude beyond the outlet end 22 (or beyond the outlet aperture 23), but is instead arranged within the outlet 20 and withdrawn from the outlet end 22 (outlet aperture 23).

In the embodiment depicted in FIG. 2, the nebuliser outlet 20 is configured such that the liquid capillary 10 will interfere with an inner wall of the nebuliser outlet when the liquid capillary 10 is installed in the nebuliser outlet 20. For example, the nebuliser outlet 20 is configured such that the liquid capillary 10 will interfere with an inner wall of (the tapered region of) the first channel 24 when the liquid capillary 10 is installed in the nebuliser outlet 20. The outlet 20 may be configured such that when the liquid capillary 10 interferes with an inner wall of the nebuliser outlet 20, the outlet 12 of the liquid capillary 10 is arranged within the nebuliser outlet and upstream of the nebulisation region (and cannot protrude beyond the outlet end 22, or beyond the outlet aperture 23).

Other arrangements would be possible. For example, a stop (such as one or more protrusions) may be provided on the liquid capillary 10. The stop may be attached to the liquid capillary 10 at a selected distance relative to the liquid capillary outlet 12. The stop (and optionally the first channel 24) may be configured such that, when the liquid capillary 10 is installed in the outlet 20, the stop interferes with an inner wall of the channel 24 (or with another part of the outlet 20), such that the stop (and the liquid capillary 10) cannot be moved beyond a certain (axial) position relative to the nebuliser outlet 20. This may be such that the outlet 12 of the liquid capillary 10 can be positioned at a desired position relative to the outlet aperture 23 when the liquid capillary 10 is installed in the outlet 20.

The nebuliser outlet may be configured in this way to ensure that the liquid is directly provided to the nebulisation region by a channel (in particular the first channel 24) of the nebuliser outlet 20 (and such that the gas is directly provided to the nebulisation region by a channel (the second channel 25) of the nebuliser outlet 20).

In general, the nebuliser outlet 20 may be configured such that a liquid-emitting outlet of a liquid supply that supplies liquid to the outlet 20 (such as the outlet 12 of the capillary 10) is arranged upstream of the nebulisation region (such as within the nebuliser outlet 20). The nebuliser outlet 20 may be configured such that liquid from the liquid-emitting outlet of the supply is provided to a channel (in particular the first channel 24) of the nebuliser outlet 20, such that the liquid will travel at least some distance through that channel 24 (beyond the liquid-emitting outlet of the supply, i.e. without travelling through the supply) before meeting (and being nebulised by) the gas.

This ensures that the position of the ultimate liquid-emitting outlet (e.g. outlet aperture 23) (of the first channel 24) relative to the ultimate gas-emitting outlet (of the second channel 25) is substantially fixed by the geometry of the nebuliser outlet 20 alone. In other words, the geometric parameters that affect the interaction between the liquid and the nebulising gas (in the nebulisation region) are substantially fixed by the geometry of the (single piece) nebuliser outlet 20 alone.

This is in contrast with the conventional arrangement depicted in FIG. 1, where the liquid is provided to a nebulisation region by the liquid capillary 10. As described above, in such arrangements, the position of the liquid-emitting outlet of the liquid capillary 1 relative to the nebuliser outlet of the gas capillary 2 can significantly affect the properties of the nebulised spray, but it can be challenging to ensure that the position of the liquid capillary relative to the nebuliser outlet is consistently reproduced, for example from one use to the next (for example after uninstalling and re-installing the liquid capillary 1), and from one nebuliser to the next.

By instead providing a nebuliser outlet 20 it which both the liquid and the gas are directly provided to the nebulisation region by internal channels of the nebuliser outlet 20, the properties of the interaction between the liquid and the nebulising gas can be made to be independent of the precise position of the liquid-emitting outlet of a liquid supply (such as the outlet 12 of the capillary 10) relative to the nebuliser outlet 20. The effect of this is to significantly reduce variation in the performance of the nebuliser, for example from one use to the next, and from one nebuliser to the next.

As described above, in embodiments the nebuliser outlet 20 comprises (i.e. is) a single integrated component.

In this regard, the Applicant has recognised that a multi-part construction of the nebuliser outlet 20 would not be an optimum construction. In particular, the Applicant has recognised that the use of multiple components can lead to cumulative manufacturing imperfections and/or inter-part variations, but that manufacturing imperfections and/or inter-part variations can lead to the nebuliser outlet 20 producing an uneven spray.

Thus, the nebuliser outlet 20 may comprise (may be) a single component which includes the first 24 and second 25 channels. Forming the nebuliser outlet 20 as a single integrated component can significantly reduce manufacturing imperfections, and thereby reduce variation in the performance of the nebuliser outlet 20, for example from one use to the next, and from one nebuliser outlet 20 to the next.

In these embodiments, the nebuliser outlet 20 may be formed using an additive manufacturing process. The nebuliser outlet 20 may be formed from any suitable material such as a metal. Thus, the nebuliser outlet 20 may be formed using a metal additive manufacturing process.

In particular, the Applicant has found that the nebuliser outlet 20 can be formed with appropriate dimensions and precision using selective laser melting (SLM). Thus, in various particular embodiments, the nebuliser outlet 20 is formed using selective laser melting (SLM).

Selective laser melting (SLM) is an additive manufacturing process that uses a laser to melt and fuse metallic particles, which when solidified form layers of the part. A layer of powder is applied to a build platform, and the powder is selectively fused by a laser beam. The build platform is then lowered, and the procedure is repeated so as to build up layers of the part one by one. Selective laser melting (SLM) allows highly complex parts to be manufactured, and without the need for specific tooling.

The skilled person will understand that “selective laser melting” (“SLM”) is known by a number of other names, such as for example (i) direct metal laser melting (DMLM); (ii) laser powder fusion (LPF); (iii) laser powder bed fusion (LPBF); (iv) laser sintering; (v) micro laser sintering; (vi) selective laser sintering (SLS); (vii) laser deposition; (viii) laser cladding; (ix) direct metal deposition (DMD); (x) laser metal deposition (LMD); (xi) direct metal laser deposition (DMLD); (xii) direct metal casting (DMC); and so on. As used herein the term “selective laser melting” is intended to encompass all such processes.

Various other metal additive manufacturing processes could instead be used to form the nebuliser outlet 20. In particular, the nebuliser outlet 20 may be formed using electron-beam additive manufacturing (also known as electron-beam melting (EBM)). Electron-beam additive manufacturing is an additive manufacturing process that works in a similar manner to selective laser melting (SLM), but that uses an electron beam to melt and fuse metallic particles.

In particular embodiments, the nebuliser outlet 20 is formed entirely by an additive manufacturing process. In alternative embodiments the nebuliser outlet 20 may be formed using a combination of an additive manufacturing process with a (more conventional) subtractive manufacturing process. It would also be possible to form the nebuliser outlet 20 using (only) a (conventional) subtractive manufacturing process.

The nebuliser outlet 20 may be formed using the additive manufacturing process by building the nebuliser outlet 20 beginning from the outlet end 22 and proceeding to the inlet end 21. This has been found to allow more mechanically robust construction of the nebuliser outlet 20 using additive manufacturing. This also maximises the number of outlets 20 that can be simultaneously be manufactured, thereby increasing the efficiency of the manufacturing process.

However, in general the nebuliser outlet 20 of the various embodiments described herein may be formed using the additive manufacturing process in any orientation, such as for example by building the nebuliser outlet 20 beginning from the outlet end 22 and proceeding to the inlet end 21, by building the nebuliser outlet 20 beginning from the inlet end 21 and proceeding to the outlet end 22, or by building the nebuliser outlet 20 beginning from a side surface and proceeding to an opposite side surface.

The additive manufacturing process may be used to form a single nebuliser outlet 20 at a time, or to form multiple (identical or non-identical) nebuliser outlets at the same time.

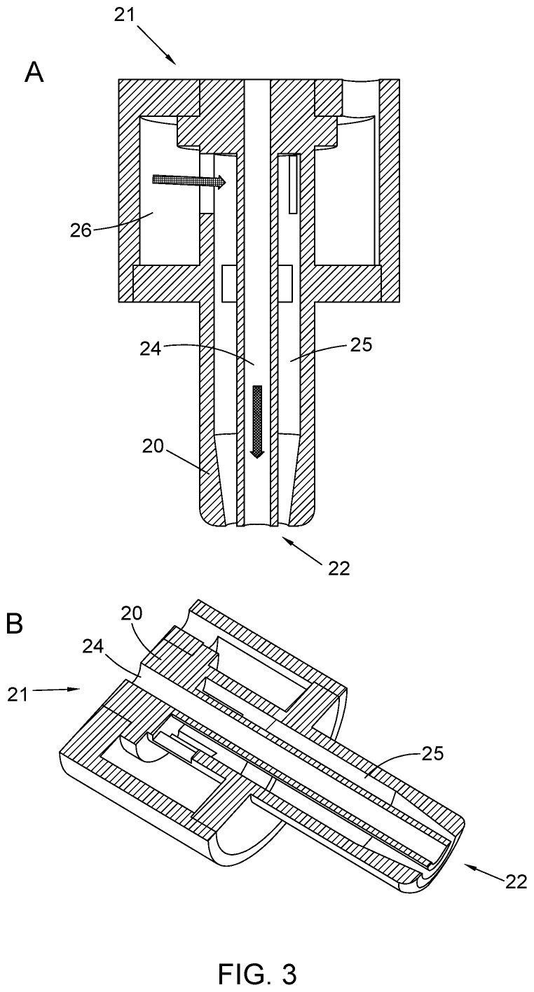

FIG. 3 shows schematically a nebuliser assembly in accordance with various further embodiments. The nebuliser assembly of FIG. 3 is substantially similar to the nebuliser assembly described above and shown in FIG. 2. The nebuliser assembly may have any one or more or each of the optional features described herein, and may be configured substantially as described elsewhere herein.

In the embodiment depicted in FIG. 3, the outlet of the first channel 24 does not protrude beyond the outlet of the second channel 25, but instead the outlet of the first channel 24 is level with the outlet of the second channel 25. It would also be possible for the outlet of the first channel 24 to be withdrawn within the outlet of the second channel 25 (i.e. for the outlet of the second channel 25 to protrude beyond the outlet of the first channel 24).

As shown in FIG. 3, the first channel 24 is configured as a tube having the same cross-sectional area (e.g. the same inner diameter) along its entire (axial) length (and does not include a tapered portion), but the second channel 25 has a tapered portion arranged at or close to the outlet end 22. It would also be possible for both the first channel 24 and the second channel 25 to be configured as tubes having the same cross-sectional area (e.g. the same inner diameter) along their entire (axial) length (and for both the first channel 24 and the second channel 25 not to include a tapered portion), or for the second channel 25 to be configured as a tube having the same cross-sectional area (e.g. the same inner diameter) along its entire (axial) length (not including a tapered portion), but the first channel 24 to have a tapered portion arranged at or close to the outlet end 22.

As also illustrated in FIG. 3, the nebuliser outlet 20 comprises one or more gas inlets to the second channel 25 that are arranged between the inlet end 21 and the outlet end 22 (i.e. not at the inlet end 21). Thus, the second channel 25 does not extend along the entire length of the nebuliser outlet 20 between the inlet end 21 and the outlet end 22. Instead, the second channel 25 extends from an intermediate position between the inlet end 21 and the outlet end 22 to the outlet end 22. It would also be possible for the second channel 25 to extend from the inlet end 21 to an intermediate position between the inlet end 21 and the outlet end 22, or between two different intermediate positions between the inlet end 21 and the outlet end 22.

Furthermore, the nebuliser outlet 20 of FIG. 3 includes a gas inlet chamber 26, such as an expansion chamber, which may be configured so that gas can be provided to the second channel 25 via the gas inlet chamber 26 (and via the one or more gas inlets). The provision of a gas inlet chamber 26 can improve the consistency of the nebuliser's performance, for example by ensuring that the gas is received by the second channel 25 at a constant pressure (e.g. independently of any pressure fluctuations in the gas supply).

As shown in FIG. 3, the gas inlet chamber 26 may be formed as a separate part to the rest of the nebuliser outlet 20 (e.g. the nebuliser outlet 20 may comprise a first additive manufactured component which includes at least the first 24 and second 25 channels, and a second component comprising the gas inlet chamber 26). In this case, the gas inlet chamber 26 part may be formed using an additive manufacturing process (as described elsewhere herein), a combination of an additive manufacturing process with a subtractive manufacturing process, or using (only) a subtractive manufacturing process. Alternatively, the entire nebuliser outlet 20 (comprising the first 24 and second 25 channels and the gas inlet chamber 26) may be formed as a single part (using an additive manufacturing process or otherwise, as described elsewhere herein).

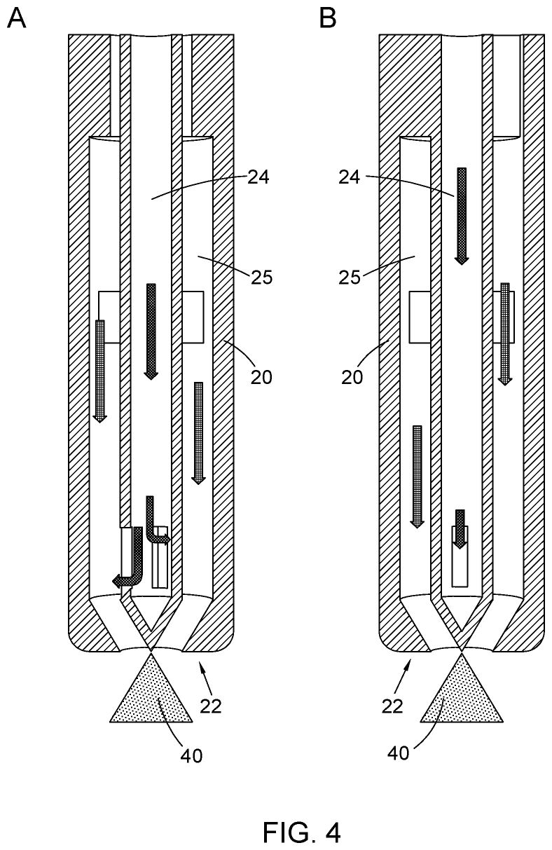

FIG. 4 shows schematically a nebuliser outlet 20 in accordance with various further embodiments. The nebuliser outlet 20 of FIG. 4 is substantially similar to the nebuliser outlet 20 described above and shown in FIGS. 2-3. The nebuliser outlet 20 may have any one or more or each of the optional features described herein, and may be configured substantially as described elsewhere herein.

As can be seen in FIG. 4, the first (liquid carrying) channel 24 does not extend along the entire length of the nebuliser outlet 20. Instead, as shown in FIG. 4, the first channel 24 extends from the inlet end 21 to an intermediate position between the inlet end 21 and the outlet end 22, i.e. the first channel 24 terminates before the outlet end 22 of the nebuliser outlet 20. It would also be possible for the first channel to extend from an intermediate position between the inlet end 21 and the outlet end 22 to the outlet end 22, or between two different intermediate positions between the inlet end 21 and the outlet end 22.

In the embodiment depicted in FIG. 4, the first channel 24 has one or more liquid outlets that are arranged between the inlet end 21 and the outlet end 22 (i.e. not at the outlet end 22). Furthermore, the one or more liquid outlets are configured to outlet liquid into the one or more second channels 25. Thus, the first channel 24 and the second channel 25 may converge at one or more convergence regions within the nebuliser outlet 20. As shown in FIG. 4, the convergence region(s) may be arranged to be relatively close to the outlet end 22.

In FIG. 4, the one or more outlets of the first channel 24 are configured such that liquid leaving the first channel 24 meets the gas in the second channel 25. That is, the nebuliser outlet 20 is configured such that the liquid will meet (and interact with) the nebulising gas in one or more regions within the body of the nebuliser outlet 20, upstream of the outlet end 22. Thus, the nebuliser outlet 20 may be configured such that one or more nebulisation regions are provided within the nebuliser outlet 20, upstream of the outlet end 22 (where the one or more convergence regions are the one or more nebulisation regions).

In this way, the nebuliser outlet 20 is configured in such that the liquid is directly provided to the nebulisation region(s) by the first channel 24, and such that the gas is directly provided to the nebulisation region(s) by the second channel 25. In these embodiments, nebulisation may occur by a “cross-flow” of nebulising gas meeting the liquid flow in the convergence region(s).

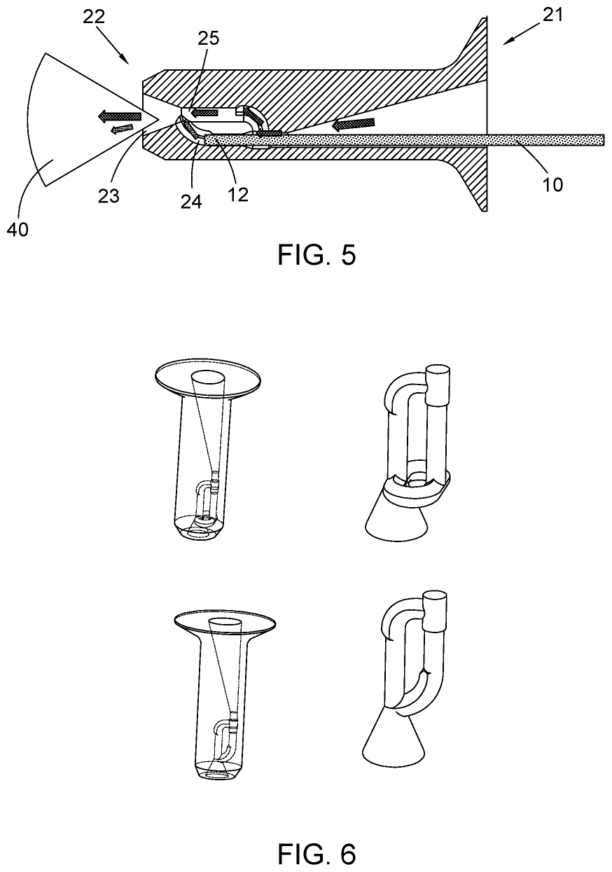

FIG. 5 shows schematically a nebuliser assembly in accordance with various further embodiments. The nebuliser assembly of FIG. 5 is substantially similar to the nebuliser assemblies described above and shown in FIGS. 2-4. The nebuliser assembly may have any one or more or each of the optional features described herein, and may be configured substantially as described elsewhere herein.

As can also be seen in FIG. 5, in these embodiments, the first channel 24 is offset from (not coaxially aligned with) the central axis of the outlet 20 and/or the outlet aperture 23 (in a radial direction), while most or all of the second channel 25 may be coaxially aligned with the central axis of the outlet 20 and/or the outlet aperture 23 (although this need not be the case). The first channel 24 may be arranged between the inlet end 21 and the outlet end 22, and may extend along only part (some but not all) of the length of the nebuliser outlet 20 between the inlet end 21 and the outlet end 22. The second channel 25 may be arranged between the inlet end 21 and the outlet end 22, and may extend along only part (some but not all) of the length of the nebuliser outlet 20 between the inlet end 21 and the outlet end 22.

The second channel 25 may diverge from the first channel 24 at some intermediate point along the length of the nebuliser outlet 20. The first channel 24 may be separate from the second channel 25 for at least some (but not all) of the length of the nebuliser outlet 20.

The first channel 24 and the second channel 25 may converge at one or more convergence region(s) within the nebuliser outlet 20, where the convergence region(s) may be arranged at or close to the outlet end 22 and/or the outlet aperture 23. As shown in FIG. 5, the nebuliser outlet 20 is configured such that gas provided to the inlet end 21 can meet (and nebulise) liquid emitted by the capillary 10 in the convergence region(s). In other words, the convergence region(s) is a nebulisation region(s).

Thus, in these embodiments, the nebuliser outlet 20 may again be configured such that the first 24 and second 25 channels converge at a convergence region(s) within the nebuliser outlet 20, where nebulisation can occur by a “cross-flow” of nebulising gas meeting the liquid flow in the convergence region(s).

As shown in FIG. 5, the second channel(s) 25 may diverge from the first channel(s) 25 by one or more curve(s) or bend(s) in the second channel(s) 25. The first channel(s) 25 may converge with the one or more second channels 25 by one or more curve(s) or bend(s) in the first channel(s) 25. Other arrangements would be possible.

As also shown in FIG. 5, the first channel 24 of the nebuliser outlet 20 may be configured to receive a liquid capillary 10. The nebuliser outlet 20 may be configured such that, when a capillary 10 is installed in the first channel 24 of the nebuliser outlet 20, the outlet 12 of the capillary is arranged upstream of (withdrawn from) the convergence region(s) at which the first 24 and second 25 channels converge. (However, as described above, a liquid capillary 10 is not essential).

In particular, the nebuliser outlet 20 is configured such that the liquid capillary 10 will interfere with an inner wall of the nebuliser outlet when the liquid capillary 10 is installed in the nebuliser outlet 20. The nebuliser outlet 20 may be configured such that the liquid capillary 10 will interfere with an inner wall of the curve or bend in the first channel 24 when the liquid capillary 10 is installed in the nebuliser outlet 20.

The nebuliser outlet may be configured in this way to ensure that the liquid is directly provided to the nebulisation region(s) by the first channel(s) 24 (and such that the gas is directly provided to the nebulisation region(s) by the second channel(s) 25). Liquid from the capillary 10 will travel at least some distance through the first channel(s) 24 before meeting (and being nebulised by) the gas. This again ensures that the geometric parameters that affect the interaction between the liquid and the nebulising gas (in the nebulisation region(s)) are substantially fixed by the geometry of the nebuliser outlet 20 alone.

The first channel 24 may also be configured such that at least part of the first channel 24 (such as the part of the first channel that will surround the outlet 12 of the liquid capillary 10 when the liquid capillary 10 is installed in the first channel 24) has a cross-sectional area (e.g. diameter) that is similar to (e.g. equal to or slightly larger than) the cross-sectional area (e.g. outer diameter) of the capillary 10. This means that most or all of the gas received by the outlet 20 (at the inlet end 21) will (be forced to) pass to the outlet end 22 via the one or more second channel(s) 25. The nebuliser outlet may be configured in this way to ensure that the gas is directly provided to the nebulisation region(s) by the second channel(s) 25.

As also shown in FIG. 5, the nebuliser outlet 20 may comprise a funnel part arranged at or close to the inlet end 21. The funnel part may be configured such that its cross-sectional area (its inner diameter) decreases from the inlet end 21 towards the outlet end 22. Arranging a funnel part at the inlet end 21 of the nebuliser outlet 20 facilitates more straightforward installation of the liquid capillary 10 in the nebuliser outlet 20, as the funnel part may in effect guide the liquid capillary 10 into the nebuliser outlet 20 when the liquid capillary 10 is being installed, for example so as to avoid the liquid capillary 10 snagging when it is being installed in the outlet 20. This is particularly beneficial as installation of the liquid capillary 10 can effectively be “blind”, where the inlet cannot be seen by a user.

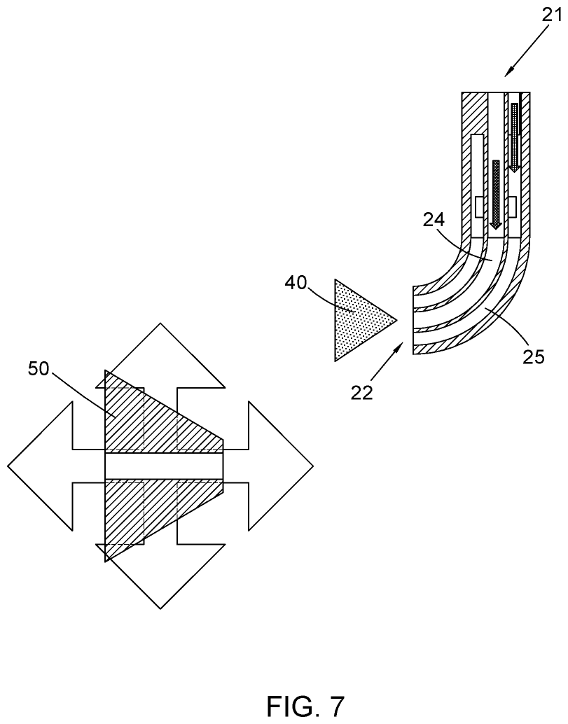

FIG. 6 shows extracted “wet” volumes of the nebuliser outlet 20 of FIG. 5 in accordance with various embodiments. As shown in FIG. 6, there may be any number of fluid entry points from the first channel 24 to the convergence (nebulisation) region, such as one, or more than one (e.g. two) fluid entry points to the convergence (nebulisation) region. Other arrangements would be possible.

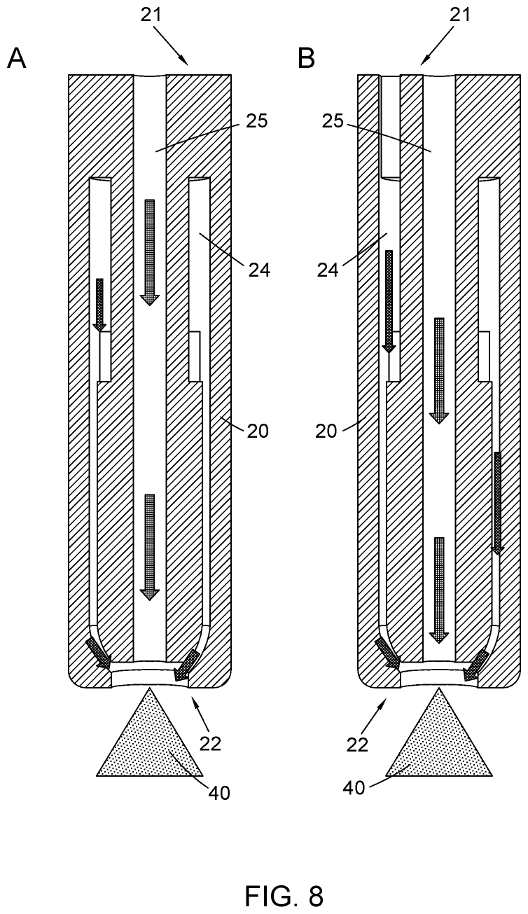

FIG. 7 shows schematically a nebuliser outlet 20 in accordance with various further embodiments. The nebuliser outlet 20 of FIG. 7 is substantially similar to the nebuliser outlets 20 described above and shown in FIGS. 2-6. The nebuliser outlet 20 may have any one or more or each of the optional features described herein, and may be configured substantially as described elsewhere herein.

As shown in FIG. 7, the nebuliser outlet 20 need not be straight, but may instead include one or more curved portions and/or one or more bends. Equally, the nebuliser outlet 20 may be configured to emit a spray of droplets 40 in any direction, which direction need not be the same as the direction in which the gas and/or liquid is introduced into the outlet 20.

In particular, as shown in FIG. 7, the first 24 and/or second 25 channels may both include a curve, which may be aligned with one another such that the first 24 and second 25 channels remain aligned along the outlet 20. In FIG. 7, the nebuliser outlet 20 is configured such that it will emit a spray of droplet 40 in a direction orthogonal to the direction in which the gas and/or liquid is introduced into the outlet 20 (and the channels of the nebuliser outlet 20 include a 90° curve), but it would be possible for the nebuliser outlet 20 to be configured to emit a spray of droplet 40 in any direction, i.e. to include any degree of curve.

Including a curve or bend in the nebuliser outlet 20 can increase the utility and flexibility of the nebuliser outlet 20. For example, as illustrated in FIG. 7, this can allow the outlet 20 to be installed in such a way that the outlet end 22 can be aligned with an inlet 50 (such as an atmospheric pressure interface) of an analytical instrument (such as a mass and/or ion mobility spectrometer), where this would otherwise not be possible (e.g. due to the geometry and/or configuration of the instrument). This may in turn improve sensitivity of the instrument.

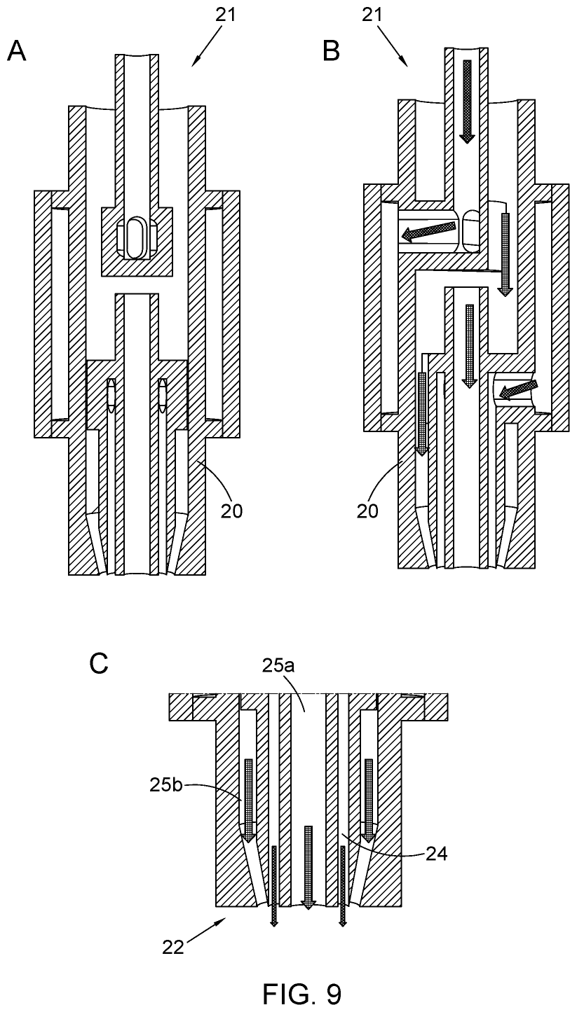

FIG. 8 shows schematically a nebuliser outlet 20 in accordance with various further embodiments. The nebuliser outlet 20 of FIG. 8 is substantially similar to the nebuliser outlets 20 described above and shown in FIGS. 2-7. The nebuliser outlet 20 may have any one or more or each of the optional features described herein, and may be configured substantially as described elsewhere herein.

As described above, in various embodiments, the gas channel 25 (coaxially) surrounds the liquid channel 24, and the outlet of the second channel 25 (coaxially) surrounds the outlet of the first channel 24. The liquid is emitted from the outlet of the first channel 24 in the form of a column, and is nebulised by an annular gas flow (emitted from the outlet of the second channel 25) that (coaxially) surrounds the column of liquid.

As shown in FIG. 8, in various other embodiments, the liquid channel 24 may (coaxially) surround the gas channel 25. Thus, the one or more second channels 25 may comprise (at least in part) a tube such as a generally cylindrical tube (which may be arranged along the central axis of the nebuliser outlet 20). The one or more first channels 24 may comprise an annular channel, where the annular first channel 24 may (coaxially) surround the (central) second channel 25 for some or most of the length of the nebuliser outlet 20. Alternatively, the one or more first channels 24 may comprise a segmented annular channel, i.e. where the cross-sectional shape of each of the one or more first channels 24 approximately corresponds to an annular sector (annulus sector), where the segmented annular first channel 24 may (coaxially) surround the (central) second channel 25 for some or most of the length of the nebuliser outlet 20. The annular channel 24 can be segmented into any suitable number of channels, such as two, three, four, five, etc. channels.

In these embodiments, the outlet of the first channel 24 may (coaxially) surround the outlet of the second channel 25. Gas exiting the outlet of the second channel 25 will meet and nebulise the liquid exiting the outlet of the first channel 24. The gas may be emitted from the outlet of the second channel 25 in the form of a column, and may nebulise an annular liquid flow (emitted from the outlet of the first channel 24) that (coaxially) surrounds the column of gas.

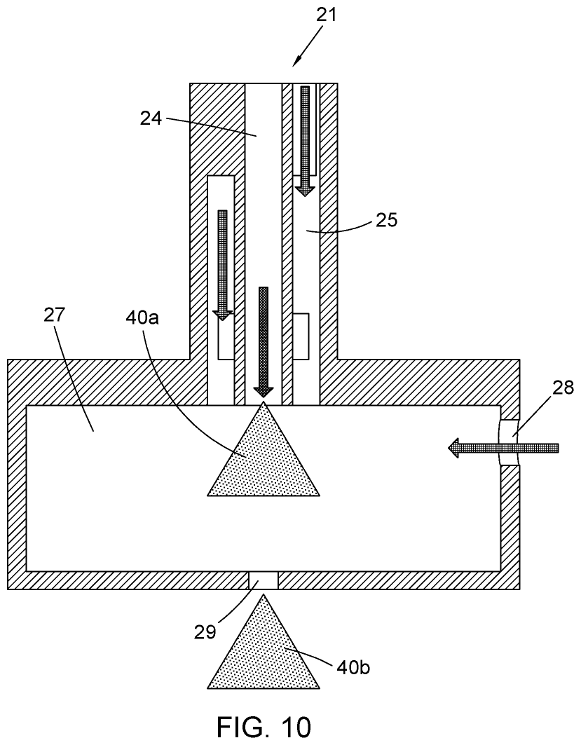

FIG. 9 shows schematically a nebuliser outlet 20 in accordance with various further embodiments. The nebuliser outlet 20 of FIG. 9 is substantially similar to the nebuliser outlets 20 described above and shown in FIGS. 2-8. The nebuliser outlet 20 may have any one or more or each of the optional features described herein, and may be configured substantially as described elsewhere herein.

As shown in FIG. 9, the nebuliser outlet 20 may be configured such that the liquid is nebulised both by a flow of gas which (coaxially) surrounds the liquid, and a flow of gas that is provided within the liquid column. This has been found to provide improved nebulisation (e.g. smaller droplets are produced on average), since a greater proportion (i.e. a greater surface area) of the liquid is reached (and nebulised) by the gas.

Thus, as illustrated in FIG. 9, the one or more second (gas) channels 25 may comprise an inner channel 25a (at least in part) in the form of a tube such as a generally cylindrical tube (which may be arranged along the central axis of the nebuliser outlet 20), and an outer annular (or segmented annual) channel 25b. The one or more first channels 24 may comprise an annular (or segmented annual) channel. The (annular) first channel 24 may (coaxially) surround the inner second channel 25a for some or most of the length of the nebuliser outlet 20. The (annular) outer second channel 25b may (coaxially) surround the (annular) first channel 24 for some or most of the length of the nebuliser outlet 20.

Similarly, the (annular) outlet of the first channel 24 may (coaxially) surround the outlet of the inner second channel 25a, and the (annular) outlet of the outer second channel 25b may (coaxially) surround the outlet of the first channel 24. Gas exiting the outlet of the inner second channel 25a will meet and nebulise the liquid exiting the (annular) outlet of the first channel 24. The gas may be emitted from the outlet of the inner second channel 25a in the form of a column, and may nebulise an annular liquid flow (emitted from the outlet of the first channel 24) that (coaxially) surrounds the column of gas. In addition, the liquid is nebulised by an annular gas flow (emitted from the outlet of the outer second channel 25b) that (coaxially) surrounds the liquid.

FIG. 9 also illustrates how, in these embodiments, the nebuliser outlet 20 may comprise a single gas inlet arranged at the inlet end 21, and a single liquid inlet arranged at the inlet end 21. However, it would also or instead be possible for the nebuliser outlet 20 to comprise any number of gas and/or liquid inlets, and for one or more or each inlet to be located elsewhere, for example between the inlet end 21 and the outlet end 22 (as described elsewhere herein).

The one or more first channels 24 are configured to pass liquid from the liquid inlet(s) to the outlet end 22 (as indicated by the arrows in FIG. 9B), such that the liquid is emitted from the (annular) liquid outlet. Similarly, the one or more second channels 25 are configured to pass gas from the gas inlet(s) to the outlet end 22 (as indicated by the arrows in FIG. 9B), such that the gas is emitted from both the inner gas outlet and the outer (annular) gas outlet.

The nebuliser outlet 20 of FIG. 9 may be formed as a single part (using an additive manufacturing process or otherwise, as described elsewhere herein), or as multiple parts (where one or more or each part may be formed using an additive manufacturing process or otherwise, as described elsewhere herein).

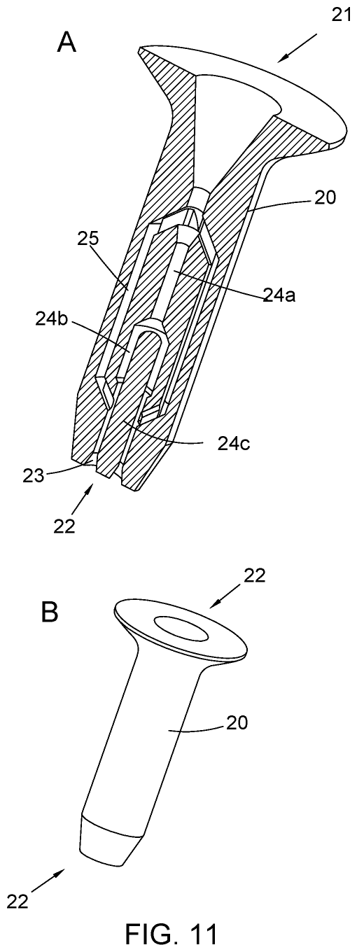

FIG. 10 shows schematically a nebuliser outlet 20 in accordance with various further embodiments. The nebuliser outlet 20 of FIG. 10 is substantially similar to the nebuliser outlets 20 described above and shown in FIGS. 2-9. The nebuliser outlet 20 may have any one or more or each of the optional features described herein, and may be configured substantially as described elsewhere herein.

As shown in FIG. 10, the nebuliser may comprise a secondary nebulisation region 27, optionally in the form of an enclosed chamber arranged at the outlet end 22 of an initial nebuliser outlet 20 (which may be configured as described elsewhere herein). An initial spray of droplets 40a emitted from the initial nebuliser outlet 20, may be introduced into the secondary nebulisation region 27, and (additional) gas may be provided to the secondary nebulisation region 27, e.g. via one or more secondary gas inlets 28 to the secondary nebulisation region 27. It would also or instead be possible for gas to be provided to the secondary nebulisation region 27 via the gas inlet(s) to the initial nebuliser outlet 20.

The gas provided to the secondary nebulisation region 27 (via one or more secondary gas inlets 28 or otherwise) may be configured to further nebulise the initial spray of droplets 40a. The nebuliser may be configured to emit a secondary spray of droplets 40b, optionally from an outlet 29 in the secondary nebulisation region 27. This has been found to provide improved nebulisation (e.g. smaller droplets are produced on average).

The nebuliser outlet 20 of FIG. 10 may be formed as a single part (using an additive manufacturing process or otherwise, as described elsewhere herein), or as multiple parts (where one or more or each part may be formed using an additive manufacturing process or otherwise, as described elsewhere herein).

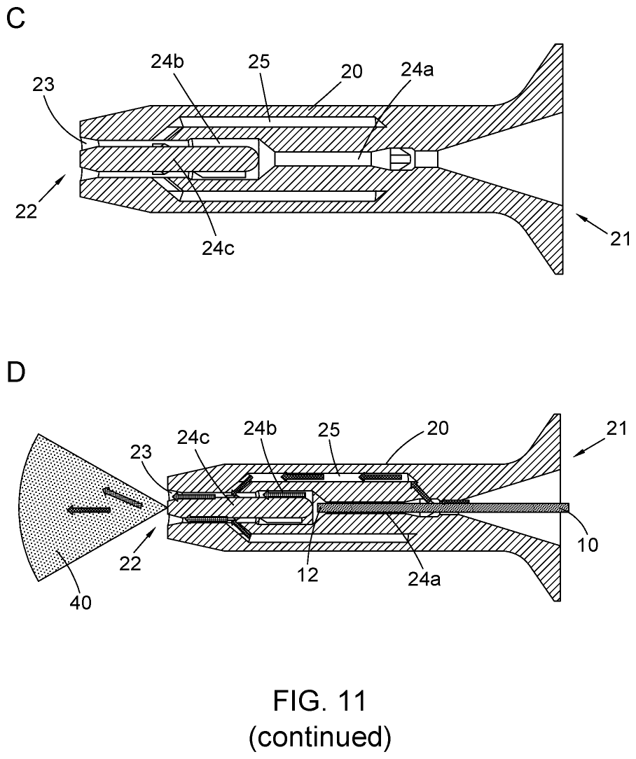

FIG. 11 shows schematically a nebuliser outlet 20 in accordance with various further embodiments. The nebuliser outlet 20 of FIG. 11 is substantially similar to the nebuliser outlets 20 described above and shown in FIGS. 2-10. The nebuliser outlet 20 may have any one or more or each of the optional features described herein, and may be configured substantially as described elsewhere herein.

As shown in FIG. 11, the nebuliser assembly comprises a nebuliser outlet 20 which has an inlet end 21 and an outlet end 22. The nebuliser outlet 20 may have a central axis, which may extend between the inlet end 21 and the outlet end 22 in an axial direction. A radial direction may extend outwardly from the central axis (may have the central axis as its origin).

The outlet end 22 of the nebuliser outlet 20 may comprise an annular outlet aperture 23, which may be arranged coaxial with the central axis of the nebuliser outlet 20. The nebuliser outlet 20 is configured to emit a spray of droplets 40 (generally in the axial direction), such as a spray of nebulised droplets, from its outlet end 22 (e.g. from the outlet aperture 23). To do this, the nebuliser outlet 20 is configured to receive a flow of liquid and a flow of gas, and to cause the liquid to be nebulised by the gas so as to produce the spray of droplets 40.

The nebuliser outlet 20 is configured to receive the flow of gas at its inlet end 21. Similarly, the nebuliser outlet is configured to receive the flow of liquid at its inlet end 21. Other arrangements would be possible (as described elsewhere herein).

As shown in FIG. 11, the nebuliser outlet 20 comprises one or more first (internal) channels 24a, 24b arranged between the inlet end 21 and the outlet end 22. The first channel(s) comprise a first portion 24a and a second portion 24b that together extend along the nebuliser outlet 20 between the inlet end 21 and the outlet end 22 (the outlet aperture 23). The first portion 24a may be configured to extend between the inlet end 21 and the second portion 24b. The second portion 24b may be configured to extend between the first portion 24a and the outlet end 22 (the outlet aperture 23).

As illustrated in FIG. 11D, the nebuliser outlet 20 may be configured to receive the flow of liquid from a liquid capillary 10 (which may be configured as described above). (However, as described above, a liquid capillary 10 is not essential). In particular, the first part 24a of the first channel(s) 24 may be configured to receive the liquid capillary 10 when the liquid capillary 10 is installed in the nebuliser outlet 20.

The first portion 24a of the first channel(s) 24 may have any suitable form. For example, the first portion 24a of the first channel(s) 24 may be (at least in part) a tube such as a generally cylindrical tube (which may be arranged along the central axis of the nebuliser outlet 20). The first portion 24a of the first channel(s) 24 may have any suitable cross sectional shape, such as a circular, elliptical or other shape.

The first portion 24a of the first channel(s) 24 may have the same cross-sectional area (e.g. the same inner diameter) along its entire (axial) length. Alternatively, the first portion 24a of the first channel(s) 24 may have plural different cross sectional areas (plural different inner diameters) along its (axial) length. For example, as shown in FIG. 11, the first portion 24a of the first channel(s) 24 may have a funnel portion arranged at or close to the inlet end 21, i.e. where the tapered portion is configured such that its cross-sectional area (its inner diameter) decreases from the inlet end 21 towards the outlet end 22. This facilitates more straightforward installation of the liquid capillary 10 in the nebuliser outlet 20 (as described above).

The first portion 24a of the first channel(s) 24 may also be configured such that at least part of the first portion 24a of the first channel(s) 24 (such as the part of the first portion 24a of the first channel(s) 24 that will surround the outlet 12 of the liquid capillary 10 when the liquid capillary 10 is installed in the first channel 24) has a cross-sectional area (e.g. diameter) that is similar to (e.g. equal to or slightly larger than) the cross-sectional area (e.g. outer diameter) of the capillary 10. This means that most or all of the gas received by the outlet 20 (at the inlet end 21) will pass to the outlet end 22 via the one or more second channel(s) 25. The nebuliser outlet may be configured in this way to ensure that the gas is directly provided to the nebulisation region(s) by the second channel(s) 25.

The second portion 24b of the first channel(s) is configured to pass liquid (e.g. from the capillary 10) to the outlet end 22 (to the outlet aperture 23) (as indicated by the arrows in FIG. 11D). In other words, the second portion 24b of the first channel(s) is configured such that liquid received by the nebuliser outlet 20 (e.g. from the capillary 10) is passed to the outlet end 22 (to the outlet aperture 23) via the second portion 24b of the first channel(s).

The second portion 24b of the first channel(s) 24 may have any suitable form. The second portion 24b may comprise one or more channels, where the or each channel 24b may have any suitable form. For example, the or each channel 24b may be a tube such as a generally cylindrical tube. The or each channel 24b may have any suitable cross sectional shape, such as a circular, elliptical or other shape.

As shown in FIG. 11, the or each of the one or more channels 24b may be arranged to run alongside the central axis of the nebuliser outlet 20, such as being (at least in part) parallel to the central axis of the nebuliser outlet 20. However, one or more or each channel 24b need not be entirely or precisely parallel to the central axis. In general, one or more or each channel 24b may have any suitable configuration such as a tapered configuration, zig-zag configuration, helix configuration, matrix configuration, and the like.

The second portion 24b may comprise any suitable number of channels. For example, the second portion 24b may comprise a single channel, or plural channels, such as two, three, four, five or more channels. Where there are plural channels, each channel may be substantially identical (although this need not be the case), and may for example, be arranged in a rotationally symmetric configuration (about the central axis of the nebuliser outlet 20) (although this need not be the case).

In particular embodiments, the second portion 24b comprises a (single) annular channel. The annular channel 24b may coaxially surround the central axis. Alternatively, the second portion 24b may comprise a segmented annular channel, i.e. where the cross-sectional shape of each of the one or more channels 24b approximately corresponds to an annular sector (annulus sector). The segmented annular channel 24b may coaxially surround the central axis. The annular channel 24b can be segmented into any suitable number of channels, such as two, three, four, five, etc. channels. Other arrangements would be possible.

The nebuliser outlet 20 comprises one or more second (internal) channels 25 arranged between the inlet end 21 and the outlet end 22. The one or more second channels 25 are configured to pass gas to the outlet end 22 (as indicated by the arrows in FIG. 11D). In other words, the one or more second channels 25 are configured such that gas received by the nebuliser outlet 20 is passed to the outlet end 22 via the one or more second channels 25.

The or each second channel 25 may have any suitable form. For example, the or each second channel may be a tube such as a generally cylindrical tube. The or each second channel may have any suitable cross sectional shape, such as a circular, elliptical or other shape. The nebuliser outlet 20 may comprise any suitable number of second channels (as described above). The one or more channels 25 comprises an annular channel or a segmented annular channel (as described elsewhere herein).

As shown in FIG. 11, the or each of the one or more second channels 25 may each be arranged to run alongside the central axis of the nebuliser outlet 20, such as being (at least in part) parallel to the central axis of the nebuliser outlet 20 (and so parallel to the first channel(s) 24). However, one or more or each second channel need not be entirely or precisely parallel to the central axis (as described elsewhere herein).

The second channel(s) 25 may diverge from the first part 24a of the first channel(s) 24. The first channel(s) 24 may be separate from the second channel(s) 25 for at least some (but not all) of the length of the nebuliser outlet 20. The second channel(s) 25 may converge with the second part 24b of the first channel(s) 24 at one or more convergence regions (which is or are within the nebuliser outlet 20, and which may be arranged close to the outlet end 22 and/or the outlet aperture 23).

As shown in FIG. 11, the nebuliser outlet 20 is configured such that gas provided to the inlet end 21 can meet (and nebulise) liquid emitted by the capillary 10 in the convergence region(s). In other words, the one or more convergence region(s) comprises one or more nebulisation region(s). Thus, in these embodiments, the nebuliser outlet 20 may again be configured such that the first 24 and second 25 channels converge at one or more convergence regions within the nebuliser outlet 20, where nebulisation can occur by a “cross-flow” of nebulising gas meeting the liquid flow in the convergence region(s).

In these embodiments, the one or more first channels 24 are configured such that when the liquid enters (and passes through) the second portion 24b (from the first portion 24a and/or from the liquid capillary 10), the (total) surface area of the liquid is increased (relative to the (total) surface area of the liquid when it is passing through the first portion 24a and/or the liquid capillary 10). The liquid is then nebulised in the second portion 24b, i.e. where it has a greater (total) surface area (relative to the (total) surface area of the liquid when it is passing through the first portion 24a and/or the liquid capillary 10). This has been found to provide improved nebulisation (e.g. to produce smaller droplets on average), since for example, a relatively large proportion of the liquid (a larger surface area) can be reached (and nebulised) by the gas.

As shown in FIG. 11, this may be achieved by the one or more first channels 24 being configured such that the first portion 24a comprises a single tubular channel, and the second portion 24b comprises an annular (or segmented annular) channel (where the convergence/nebulisation region(s) is provided within the second portion 24b). In this case, the outer diameter of the annular channel 24b may be greater than the outer diameter of the tubular channel 24a, so as to further increase the surface area of the liquid in the second portion 24b.

An increased surface area could also be achieved e.g. by the second portion 24b comprising more channels than the first portion 24a, e.g. by the second portion 24b comprising multiple channels, and the first portion 24a comprising a single channel (where a convergence/nebulisation region is provided within each of the multiple channels). This may be such that when the liquid enters (and passes through) the second portion 24b (from the first portion 24a and/or from the liquid capillary 10), it is in effect divided out into multiple channels.

In particular embodiments, the (annular) second portion 24b of the first channel(s) defines an internal structure 24c having a surface. That is, the outlet 20 comprises a structure 24c within the (annular) second portion 24b of the first channel(s), where the surface of the structure is defined by an inner wall of the (annular) second portion 24b of the first channel(s).

The nebuliser outlet 20 may be configured such that liquid received by the outlet 20 (e.g. from the capillary 10) will encounter the surface as the liquid travels towards the outlet end 22 (from the first portion 24a and/or from the liquid capillary 10 to the second portion 24b). In particular embodiments, the surface may be configured (e.g. shaped) such that the liquid will track along the surface as the liquid moves towards the outlet end 22. This may be such that a film of liquid is formed on some or all of the surface. The one or more gas channels 25 may be configured such that the gas meets and nebulises the film of liquid. Thus, the liquid is nebulised in the form of a film of liquid (on the surface). This has been found to provide improved nebulisation (e.g. to produce smaller droplets on average), since for example, a relatively large proportion of the liquid (a larger surface area) can be reached (and nebulised) by the gas when the liquid is in the form of a film.

In these embodiments, the surface may have any suitable shape. For example, as shown in FIG. 11, the surface may comprise a curved part (e.g. hemispherical) part (which may be proximate to the inlet end 21) adjoining a tubular (e.g. cylindrical) part. In particular embodiments, the surface may have a substantially aerofoil, torpedo or cigar shape. Other arrangements would be possible.

As also illustrated in FIG. 11D, in these embodiments, the nebuliser outlet 20 may be configured such that, when a capillary 10 is installed in the first part 24a of the first channel(s) 24, the outlet 12 of the capillary is arranged upstream of the convergence region(s) at which the first 24 and second 25 channels converge. In particular, the nebuliser outlet 20 is configured such that the liquid capillary 10 will interfere with the surface of the inner structure 24c when the liquid capillary 10 is installed in the nebuliser outlet 20.

This means that the liquid is directly provided to the nebulisation region(s) by the second part 24b of the first channel(s) 24 (downstream of the outlet 12 of the capillary) (and that the gas is directly provided to the nebulisation region(s) by the second channel(s) 25.) Liquid from the capillary 10 will travel at least some distance through the second part 24b of the first channel(s) 24 before meeting (and being nebulised by) the gas. This again ensures that the geometric parameters that affect the interaction between the liquid and the nebulising gas (in the nebulisation region(s)) are substantially fixed by the geometry of the nebuliser outlet 20 alone.

The nebuliser outlet 20 of FIG. 11 may be formed as a single part (using an additive manufacturing process or otherwise, as described elsewhere herein), or as multiple parts (where one or more or each part may be formed using an additive manufacturing process or otherwise, as described elsewhere herein).

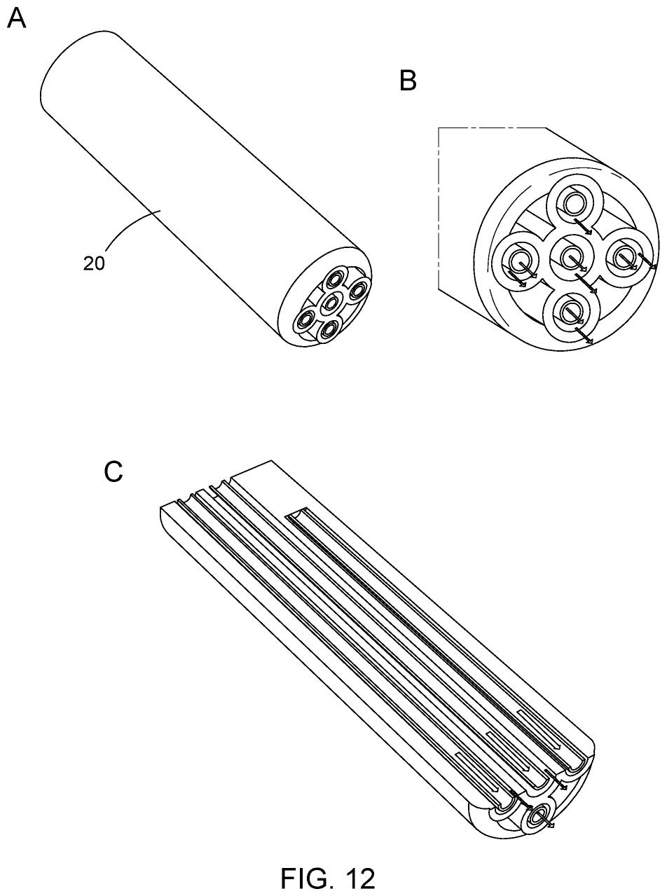

FIG. 12 shows schematically a nebuliser outlet 20 in accordance with various further embodiments. The nebuliser outlet 20 of FIG. 12 is substantially similar to the nebuliser outlets 20 described above and shown in FIGS. 2-11. The nebuliser outlet 20 may have any one or more or each of the optional features described herein, and may be configured substantially as described elsewhere herein.

As shown in FIG. 12, the nebuliser outlet 20 includes multiple outlet apertures 23. In FIG. 12, the nebuliser outlet 20 includes five outlet apertures 23, but the nebuliser outlet 20 can include any number of outlet apertures 23. As shown in FIG. 12C, each outlet aperture 23 may be fed by respective liquid and gas channels (which may each be configured as described elsewhere herein).

Although FIG. 12 shows each of the outlet apertures 23 being essentially identical, in embodiments two or more or all of the outlet apertures 23 may have different configurations, e.g. including any one or more of the configurations described herein. Similarly, although FIG. 12 shows each of the outlet apertures 23 being arranged to be level with one another (in the axial direction), it would be possible for the multiple outlet apertures 23 to be arranged in any suitable configuration. For example two or more of all of the outlet apertures may have different axial positions, e.g. where one or more of the outlets 23 protrudes beyond one or more of the other outlet apertures, where the multiple outlets 23 are arranged in a stepped or otherwise varying configuration, and so on. Other arrangements would be possible.

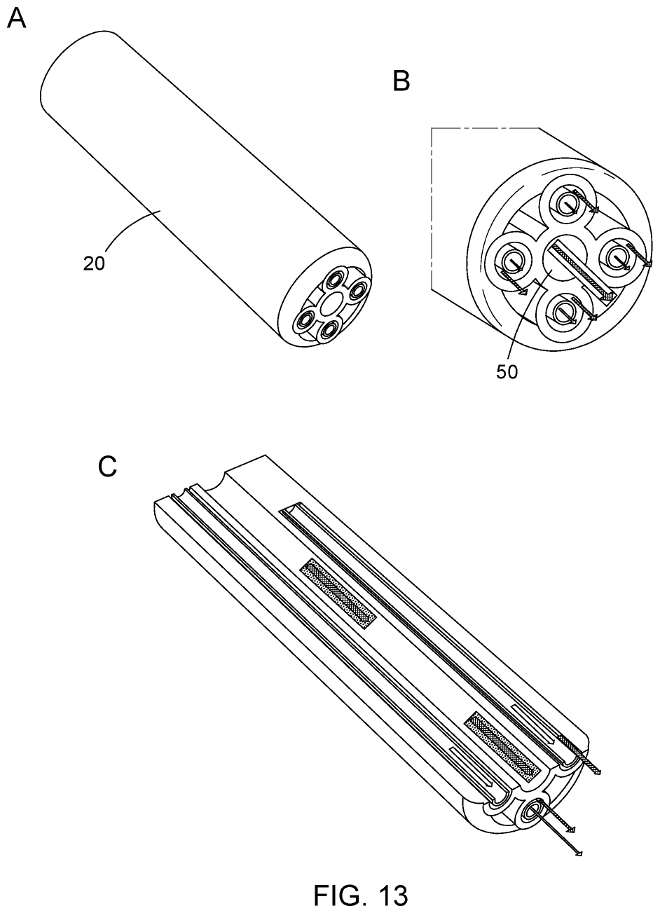

FIG. 13 shows schematically a nebuliser outlet 20 in accordance with various further embodiments. The nebuliser outlet 20 of FIG. 13 is substantially similar to the nebuliser outlets 20 described above and shown in FIGS. 2-12. The nebuliser outlet 20 may have any one or more or each of the optional features described herein, and may be configured substantially as described elsewhere herein.

As shown in FIG. 13, the nebuliser outlet 20 may include an integrated desolvation gas channel 50. A desolvation gas (such as a heated gas) may be supplied to the nebulisation region via the channel 50. This will have the effect of improving desolvation of droplets produced by the outlet 20, and can thereby improve ionisation efficiency.

Although FIG. 13 shows the integrated desolvation gas channel 50 as being a central channel in a multi-outlet aperture nebuliser outlet 20, a desolvation gas channel 50 could be integrated into a nebuliser outlet 20 in any suitable manner, and/or into any one of the embodiments described herein.

Although various individual embodiments have been described above with reference to FIGS. 2-13, it will be appreciated that each of the optional features described herein can be combined as appropriate.

It will be appreciated that various embodiments provide a single part nebuliser tip 20 which facilitates reduced variation in performance from one use to the next, and from one nebuliser to the next. The nebuliser tip 20 is configured to generate a consistent fine droplet spray with repeatable droplet size and distribution.

The nebuliser tip 20 is configured in a manner in which the geometric parameters that affect the interaction between the liquid and the nebulising gas can be substantially fixed by the geometry of the nebuliser outlet 20 alone, e.g. independently of the precise position of a capillary outlet 12 relative to the nebuliser outlet aperture 23 when a capillary 10 is installed in (the first channel 24 of) the nebuliser outlet 20.

The nebuliser tip 20 may be produced using additive manufacturing, such as Selective Laser Melting (SLM) or electron beam additive manufacturing. Traditional manufacturing techniques such as milling, turning and joining techniques would result in a multipart assembly. However, an unwanted effect of multiple part assemblies is the cumulative tolerances from the manufacturing and assembly processes. Micro Selective Laser Melting (SLM) is an additive manufacturing process which allows creation of sub millimetre sized components. This process has allowed the nebuliser assembly to be designed as a single part which eliminates the multi part tolerance build up.

Various embodiments provide a highly repeatable and optimised geometry using (e.g. SLM) additive manufacture.

The nebuliser may form part of an ion source, such as an Electrospray Ionisation (ESI) ion source. It would also be possible for the nebuliser to form part of another type of ion source that utilises a nebuliser, such as for example a Desorption Electrospray Ionisation (DESI) ion source, a Desorption Electro-Flow Focusing Ionisation (DEFFI), an impactor ion source, or an Atmospheric Pressure Chemical Ionisation (APCI) ion source.

The ion source may form part of or may be connectable to an analytical instrument, such as a mass and/or ion mobility spectrometer. Ions generated by the ion source may be analysed by the analytical instrument, e.g. so as to determine one or more physico-chemical properties of the ions, such as their mass, mass to charge ratio, ion mobility, etc.

The nebuliser is configured to emit a spray of droplets, such as a spray of nebulised droplets. To do this, the nebuliser is configured to receive a flow of liquid and a flow of gas, and to cause the liquid to be nebulised by the gas so as to produce the spray of droplets.

The flow of liquid may be a flow of solvent optionally containing analyte. The liquid may be provided to the nebuliser with a flow rate of, for example, (i) ≥ 100 μL/min; (ii) ≥200 μL/min; (iii) ≥300 μL/min; (iv) ≥400 μL/min; or (v) ≥500 μL/min. The flow of liquid may be, for example, an eluent from a liquid chromatography system. Thus, the nebuliser may be coupled to a liquid chromatography or other separation device. Alternatively, the flow of liquid may be from a (sample) reservoir.

The gas may be any suitable nebulising gas such as for example nitrogen. The gas may be provided to the nebuliser with a flow rate of, for example, (i) <100 L/hr; (ii) 100-150 L/hr; (iii) 150-200 L/hr; (iv) 200-250 L/hr; (v) 250-300 L/hr; (vi) 300-350 L/hr; (vii) 350-400 L/hr; or (viii) >400 L/hr.

In some embodiments, a voltage such as a high voltage may be applied to the nebuliser and/or liquid capillary, for example such that the spray of droplets emitted by the nebuliser comprises a spray of charged droplets, for example in the manner of an Electrospray Ionisation (ESI) ion source.

Although the present invention has been described with reference to preferred embodiments, it will be understood by those skilled in the art that various changes in form and detail may be made without departing from the scope of the invention as set forth in the accompanying claims.

1. A nebuliser outlet comprising:
one or more first channels, wherein the nebuliser outlet is configured such that liquid received by the nebuliser outlet can pass to one or more nebulisation regions via the one or more first channels; and
one or more second channels, wherein the nebuliser outlet is configured such that gas received by the nebuliser outlet can pass to the one or more nebulisation regions via the one or more second channels;
wherein the one or more first channels comprise a first portion and a second portion, wherein the first portion comprises a tubular channel, and wherein the second portion comprises multiple channels, an annular channel, or a segmented annular channel; and
wherein the one or more second channels converge with the second portion at the one or more nebulisation regions.

2. A nebuliser outlet comprising:
one or more first channels and one or more second channels;
wherein the nebuliser outlet is configured such that liquid received by the nebuliser outlet can pass to one or more nebulisation regions via the one or more first channels; and
wherein the nebuliser outlet is configured such that gas received by the nebuliser outlet can pass to the one or more nebulisation regions via the one or more second channels;
wherein the nebuliser outlet is configured such that liquid is directly provided to the one or more nebulisation regions by the one or more first channels, and such that gas is directly provided to the one or more nebulisation regions by the one or more second channels; and
wherein the nebuliser outlet comprises a single integrated component.

3. The nebuliser outlet of claim 2, wherein:
the one or more first channels comprise a tubular channel which diverges into multiple channels, an annular channel, or a segmented annular channel; and
the one or more second channels converge with the multiple channels, annular channel, or segmented annular channel of the one or more first channels at the one or more nebulisation regions.

4. The nebuliser outlet of claim 1, wherein the nebuliser outlet is configured such that a surface area of liquid provided to the nebuliser outlet is increased when the liquid passes from the tubular channel into the multiple channels, annular channel, or segmented annular channel.

5. The nebuliser outlet of claim 1, wherein the nebuliser outlet is formed using an additive manufacturing process.

6. The nebuliser outlet of claim 1, wherein the nebuliser outlet is formed using Selective Laser Melting (SLM) or electron-beam additive manufacturing.

7. The nebuliser outlet of claim 1, wherein the nebuliser outlet is configured such that gas provided to the nebuliser outlet can pass via the one or more second channels to the one or more nebulisation regions, and can nebulise liquid in the one or more nebulisation regions.

8. The nebuliser outlet of claim 1, wherein the one or more nebulisation regions are downstream of the nebuliser outlet.

9. The nebuliser outlet of claim 1, wherein the one or more nebulisation regions are within the nebuliser outlet, and the one or more first channels and the one or more second channels converge at the one or more nebulisation regions.

10. The nebuliser outlet of claim 1, wherein one or more of the second channels surrounds one or more of the first channels.

11. The nebuliser outlet of claim 1, wherein one or more of the first channels surrounds one or more of the second channels.

12. The nebuliser outlet of claim 1, wherein:
the one or more second channels comprise an inner second channel and an outer second channel; and
the one or more first channels surround the inner second channel, and the outer second channel surrounds the one or more first channels.

13. A nebuliser outlet comprising:
one or more first channels, wherein the nebuliser outlet is configured such that liquid received by the nebuliser outlet can pass to one or more nebulisation regions via the one or more first channels;
an inner second channel and an outer second channel, wherein the nebuliser outlet is configured such that gas received by the nebuliser outlet can pass to the one or more nebulisation regions via the inner second channel and the outer second channel;
wherein the one or more first channels surround the inner second channel, and wherein the outer second channel surrounds the one or more first channels.

14. The nebuliser outlet of claim 12, wherein an outlet or outlets of the one or more first channels surrounds an outlet of the inner second channel, and wherein an outlet or outlets of the outer second channel surrounds the outlet or outlets of the one or more first channels.

15. The nebuliser outlet of claim 12, further comprising a secondary nebulisation region, wherein the nebuliser outlet is configured such that an initial spray of droplets produced by the nebuliser outlet is further nebulised in the secondary nebulisation region.

16. A nebuliser comprising:
the nebuliser outlet of claim 12; and
a liquid capillary;
wherein an outlet of the liquid capillary is arranged upstream of the nebulisation region.

17. An ion source comprising the nebuliser outlet and/or the nebuliser of claim 12, optionally wherein the ion source comprises an Electrospray Ionisation (ESI) ion source, a Desorption Electrospray Ionisation (DESI) ion source, a Desorption Electro-Flow Focusing Ionisation (DEFFI) ion source, an impactor ion source, or an Atmospheric Pressure Chemical Ionisation (APCI) ion source.

18. A method of nebulising a liquid, the method comprising using the nebuliser outlet and/or the nebuliser of claim 1 to nebulise a liquid.

19. A method of manufacturing a nebuliser outlet, the method comprising manufacturing the nebuliser outlet of claim 1 using an additive manufacturing process.

20. The method of claim 19, wherein the additive manufacturing process comprises Selective Laser Melting (SLM) or electron-beam additive manufacturing.
